(19) United States
(12) Patent Application Publication
(10) Pub. No.: US 2023/0332723 A1
(43) Pub. Date: Oct. 19, 2023

(54) METHOD FOR COUPLING PLUG CONNECTORS IN ORDER TO FORM A PLUG ASSEMBLY, AND PLUG ASSEMBLY

(71) Applicant: HENN GMBH & CO KG., Dornbirn (AT)

(72) Inventor: Sven Hohlfeld, Nenzing (AT)

(73) Assignee: HENN GMBH & CO KG., Dornbirn (AT)

(21) Appl. No.: 18/010,517

(22) PCT Filed: Jun. 24, 2021
(86) PCT No.: PCT/AT2021/060222

§ 371 Date: Dec. 15, 2022

(30) Foreign Application Priority Data
Jun. 25, 2020 (AT) A50538/2020

(51) Int. Cl. F16L 37/088; F16L 37/14

(52) U.S. Cl. CPC F16L 37/0885; F16L 37/144

(57) ABSTRACT

A method for coupling plug connectors to form a plug assembly and a plug assembly is presented. A first and a second plug connector, a sealing element and a locking element are provided. The locking element is arranged in coupling slots of the first plug connector such that a base leg of the locking element is arranged in its center between its two legs in a first position spaced at a first radial distance from a first longitudinal axis. When the second plug connector is inserted into the first plug connector, first leg connection sections are supported on an insertion piece and subsequently second leg sections are supported on the widening section, and, in this process, the base leg is arranged in a second position spaced at a greater second radial distance from the longitudinal axis.

### CROSS-REFERENCE TO RELATED APPLICATIONS

This application claims priority to International Patent Application No. PCT/AT2021/060222, filed on Jun. 24, 2021, and Austrian Patent Application No. A50538/2020, filed on Jun. 25, 2020, the contents of each of which are hereby incorporated by reference in their entirety.

### TECHNICAL FIELD

This disclosure relates to a method for coupling plug connectors in order to form a plug assembly, and to a plug assembly, which is formed for connecting pipes for liquid and/or gaseous media.

### BACKGROUND

DE 10 2008 046 143 A1 describes a generic quick-coupler arrangement for fluid-conducting connection to fluid-conducting devices, having a connecting piece and a coupling which can be releasably connected thereto, as well as a sealing device arranged between the connecting piece and the coupling. A spring device is in releasable positive engagement with the coupling. The strap-shaped spring device holds the strap ring on the coupling in the axial direction. The legs of the spring device extend through the female receiving space in the tangential direction. To form the coupling position, the connecting piece must be pushed into the female receiving space of the coupling and comes into positive engagement with the legs of the spring device. The disadvantage of this is that a high axial force must be applied to expand the legs of the spring device when the connecting piece is pushed into the coupling.

EP 2 602 531 A1 describes a locking member, a connection device equipped therewith and a locking method of such a connection device. The locking member is intended for equipping a lockable connection device for fluid transfer, said connection device comprising a male tubular sleeve with a flange and a female tubular sleeve surrounded by a coupling ring and axially extended. The locking member has two elastic locking wings connected between them by means of a gripping head. The locking wings can be inserted in the tangential direction into slots formed on both sides in each case. Additional locking sleeves are arranged diametrically to each other on each of the two locking wings, said locking sleeves forming a locking position with the male tubular sleeve after the male sleeve has been fully inserted into the female sleeve. When the male sleeve is pushed in, the two locking wings are expanded in the radial direction to guide them onto the end piece of the male sleeve. After having been fully pushed in, the locking wings engage with their locking sleeves behind the flange, thus forming the locking position.

WO 2018/069384 A1 describes a connector, a connector assembly and a method for producing the connector. The connector comprises a connector housing which has a fluid duct extending away from a first opening, wherein a locking device having a locking housing and a locking element is provided in the region of the first opening. The locking housing encloses the connector housing with respect to the fluid duct in the circumferential direction such that an annular gap which concentrically surrounds the first opening and is intended for receiving a substantially cylindrical connection piece is formed between the connector housing and the locking housing. The locking element with its holding sections projects in an elastically resilient manner into the ring gap, wherein the locking housing is a component which is separate from the connector housing. The locking element is a strap which encloses the locking housing at least in some section in the circumferential direction and which projects into the ring gap with its holding section from a radially outer side. The strap lies in a groove extending in the circumferential direction in which the strap is held securely. Here, too, the holding sections of the strap are extended in the radial direction during insertion and coupling.

EP 3 244 113 A1 also describes a locking strap for a connecting piece of a quick coupling system. The connecting piece has a first receiving slot group with first receiving slots and a second receiving slot group with second receiving slots along the circumference. The locking strap in turn comprises an at least partially circumferential first strap section with a first projection group having radially inwardly directed first projections which are provided to engage in the first receiving slots of the first receiving slot group of the connecting piece. Furthermore, the locking strap comprises an at least partially circumferential second strap section with a second projection group having also radially inwardly directed second projections which are provided to engage in the second receiving slots of the second receiving slot group of the connecting piece. A bent spring section may connect the first strap section to the second strap section to form a common component, wherein the bent spring section is arranged at an angle to the first and second projection groups. However, the two strap sections may each form a separate component. The first and second projection groups of the locking strap or the respective separate strap sections form latching elements for coupling a connecting piece to a mating connecting piece insertable therein. During the coupling process, the individual projection groups of the locking strap are also expanded in the radial direction during insertion. When the locking strap is expanded radially by inserting the mating connecting piece into the connecting piece, the bent spring section is bent up and spread.

EP 2 372 209 A2 describes an exhaust gas pipe for a motor vehicle and an exhaust gas unit of a motor vehicle. A first end section and a second end section of the exhaust gas pipe are connected to each other in a gas-tight manner. The first end section has an insertion portion that is inserted into a receiving portion of the second end section. The insertion portion has a latching projection with a latching side and a run-up side that is inclined with respect to the axis of rotation, wherein a latching means abuts the latching side in the coupled position. The latching means is designed as a spring clip which is guided in a slot in the receiving portion, wherein the spring clip is U-shaped and legs of the spring clip each have an outwardly curved section whose inner radius corresponds to an outer radius of the insertion portion. This allows a relatively large contact surface for the legs on the latching projection. Here, too, the U-shaped legs of the spring clamp are widened in the radial direction during insertion and coupling, and the connecting web located between the two legs is deformed.

It was the object of the present disclosure to overcome the disadvantages of the prior art and to provide a method for coupling plug connectors and a plug assembly, by means of which a user is capable of performing an easy and effort-saving coupling operation of the plug connectors and engagement with the locking element.

### OVERVIEW

The object is achieved by means of a method and a plug assembly according to the claims.

The indicated method serves for coupling plug connectors in order to form a plug assembly, which is formed for connecting pipes for liquid and/or gaseous media. In the method, the following steps are performed:
providing a first female plug connector, said first plug connector comprising a tube-shaped first plug connector body, which defines a female receiving space with a first longitudinal axis, wherein at least a first coupling slot and a second coupling slot are arranged in the first plug connector body so as to diametrically oppose one another,
providing a second male plug connector, said second plug connector having a tube-shaped second plug connector body with
a hollow-cylindrical insertion piece,
an adjoining conically extending widening section, and with
an adjoining coupling section with at least one coupling groove, wherein the second plug connector body defines a second longitudinal axis,
providing at least one sealing element and arranging it in the first female plug connector,
providing a locking element, said locking element being strap-shaped and being in a releasable positive engagement with the two plug connectors when the plug connectors are in the coupling position, the locking element comprising
   a first leg,
   a second leg and
   a base leg, said base leg connecting the two legs to one another, each of the two legs in each case comprising
   a first leg section,
   a second leg section and
   a leg connection section, which leg connection section connects the first leg section and the second leg section to one another in each case, and the first leg sections are arranged adjoining the base leg on sides facing away from one another in each case, wherein at least the two second leg sections are aligned such that they run parallel to one another in the undeformed initial position, and furthermore the two leg connection sections are aligned such that they run towards one another in the direction of the base leg,
arranging the locking element in the two coupling slots of the first plug connector body, and, in this process, arranging the base leg of the locking element in its center between the two legs in a first position spaced at a first radial distance from the first longitudinal axis,
mutual, preferably aligned, orientation of the longitudinal axes of the two plug connectors with respect to each other,
moving the two plug connectors towards each other and step by step inserting the second plug connector into the female receiving space of the first plug connector,
   (a) inserting the hollow-cylindrical insertion piece, in which the two leg connection sections are each arranged in a partial section thereof directly adjacent to the hollow-cylindrical insertion piece or resting on the hollow-cylindrical insertion piece against first contact sections,
   (b) continuing the insertion process in the axial direction, in which the two second leg sections are each supported on the conically extending widening section adjoining further contact sections, and, in this process, the base leg of the locking element is arranged in its center between the two legs in a second position at a second radial distance from the longitudinal axis, and the second radial distance has a greater value than the first radial distance,
   (c) continuing the insertion process in the axial direction, in which, when the first and second plug connectors are in the mutual coupling position, the locking element engages with its second leg section of the first leg in the first coupling slot and in the coupling groove, and the second leg engages with its second leg section in the second coupling slot and in the coupling groove.

In the presently selected method steps, it is advantageous that by the provision of the leg connection section located between the first and second leg sections and the change of the support point and/or support section or contact section from the two leg connection sections to the second leg sections arranged further away from the base leg, an increase in the free bending length of the legs and thus a reduction in the insertion force (axial force) to be applied is achieved. By moving the contact points or contact sections along the legs of the locking element and the associated increase of the transverse and/or radial distance between the base leg and the longitudinal axis during the joining and/or insertion process, the required widening force of the legs from one another is reduced and thus the insertion force (axial force) to be applied is reduced, too. This is achieved by the extension of the two levers or lever arms on the respective legs of the locking element.

Furthermore, an approach is advantageous in which, when the coupling position is reached, the locking element with its base leg is moved back to the first position. This moves the locking element with its base leg closer to the longitudinal axis again, whereby the bending length of the legs can be reduced and the holding force can be increased.

A further advantageous approach is characterized in that during step (a) of the axial insertion process of the second plug connector into the female receiving space of the first plug connector, the two second leg sections are each arranged at a distance from the hollow cylindrical insertion piece in the radial direction. Hence, a clear contact and support of the two leg connection sections on the insertion piece can be achieved during the axial adjustment movement. Only when the outwardly expanding widening section is reached, the displacement of the contact section between the locking element and the second plug connector body can be initiated and begun.

A method variant in which the two leg connection sections are lifted off the conically extending widening section after the beginning of step (b) is also advantageous. Hence, it can be ensured that the contact point or the contact section can be clearly determined and defined. Furthermore, hence, the occurring friction force can be kept low.

Another approach is characterized in that during step (b) of the axial insertion process, the radial distance of the center of the base leg is continuously increased starting from the value of the first radial distance to the second value of the second radial distance. In this way, a constant extension of the free bending length can be achieved. The further the two legs are widened from each other, the greater the free bending length also becomes and the insertion force can be kept within small limits.

It is also advantageous to arrange or accommodate the two leg connection sections of the locking element in the coupling groove over the majority of their length when the plug connectors are in the coupling position. Hence, an even better fixation and a higher positive engagement can be achieved in the locking position of the legs of the locking element.

A further advantageous approach is characterized in that the base leg of the locking element, in particular its central section, is supported resting against the first plug connector at least in the coupling position. Hence, a clearer positioning of the locking element at the first plug connector can be achieved.

A method variant in which the value of the second radial distance of the base leg from the longitudinal axis amounts to a maximum after leaving the widening section of the two legs and prior to the respective insertion of the two second leg sections into the coupling groove is also advantageous. Hence, the maximum extension of the free bending length of each of the legs can be achieved at the largest radial widening of the two legs.

However, the object of the disclosure is also achieved independently thereof by a plug assembly according to the features indicated below.

The plug assembly is embodied for connecting pipes for liquid and/or gaseous media and comprises:
a first female plug connector, said first plug connector comprising a tube-shaped first plug connector body, which defines a female receiving space with a first longitudinal axis, wherein at least a first coupling slot and a second coupling slot are arranged in the first plug connector body so as to diametrically oppose one another,
a second male plug connector, said second plug connector having a tube-shaped second plug connector body with
a hollow-cylindrical insertion piece,
an adjoining conically extending widening section, and with
an adjoining coupling section with at least one coupling groove, wherein the second plug connector body defines a second longitudinal axis,
wherein the two plug connectors can be brought into a releasable coupling position in the axial direction,
at least one sealing element, said sealing element being arranged in the first female plug connector,
a locking element, said locking element being strap-shaped and being in a releasable positive engagement with the two plug connectors in the coupling position, the locking element comprising:
   a first leg,
   a second leg and
   a base leg, said base leg connecting the two legs to one another, each of the two legs in each case comprising:
   a first leg section,
   a second leg section and
   a leg connection section, which leg connection section connects the first leg section and the second leg section to one another in each case, and the first leg sections are arranged adjoining the base leg on sides facing away from one another in each case, wherein at least the two second leg sections are aligned such that they run parallel to one another in the undeformed initial position, and furthermore the two leg connection sections are aligned such that they run towards one another in the direction of the base leg,
wherein, when the first and second plug connectors are in the coupling position, the locking element engages with its first leg in the first coupling slot and in the coupling groove and the second leg engages in the second coupling slot and in the coupling groove, and
wherein the base leg of the locking element, at least in the coupling position, is arranged in its center between the two legs in a first position spaced apart from the longitudinal axis at a first radial distance, and wherein it is further provided
that, at the beginning of axial insertion of the second plug connector into the female receiving space of the first plug connector, in each case the two leg connection sections are arranged in a partial section thereof directly adjacent to the hollow-cylindrical insertion piece or resting on the hollow-cylindrical insertion piece against first contact sections,
that, during further insertion in the axial direction, the two second leg sections are in each case supported resting against further contact sections on the conically extending widening section,
that, at least in the position of the second leg sections resting against the conically extending widening section, the base leg of the locking element is arranged in its center between the two legs in a second position at a second radial distance from the longitudinal axis, and
that the second radial distance has a greater value than the first radial distance.

The advantage achieved by this consists in that by the provision of the leg connection section located between the first and second leg sections and the change of the support point and/or support section or contact section from the two leg connection sections to the second leg sections arranged further away from the base leg, an increase in the free bending length of the legs and thus a reduction in the insertion force (axial force) to be applied is achieved. By moving the contact points or contact sections along the legs of the locking element and the associated increase of the transverse and/or radial distance between the base leg and the longitudinal axis during the joining and/or insertion process, the required widening force of the legs from one another is reduced and thus the insertion force (axial force) to be applied is reduced, too. This is achieved by the extension of the two levers or lever arms on the respective legs of the locking element.

Furthermore, it can be advantageous if the base leg is set back into its first position when the locking element is in the coupling position. This moves the locking element with its base leg closer to the longitudinal axis again, whereby the bending length of the legs can be reduced and the holding force can be increased.

Another embodiment is characterized in that during the beginning of the axial insertion of the second plug connector into the female receiving space of the first plug connector, the two second leg sections are each arranged at a distance from the hollow cylindrical insertion piece in the radial direction. Hence, a clear contact and support of the two leg connection sections on the insertion piece can be achieved during the axial adjustment movement. Only when the outwardly expanding widening section is reached, the displacement of the contact section between the locking element and the second plug connector body can be initiated and begun.

A further possible embodiment has the features that when the two second leg sections are supported on the conically extending widening section, the two leg connection sections are arranged at a distance from the conically extending widening section. Hence, it can be ensured that the contact point or the contact section can be clearly determined and defined. Furthermore, hence, the occurring friction force can be kept low.

In a further embodiment, it is provided that the two leg connection sections of the locking element are arranged or accommodated in the coupling groove over the majority of their length when the plug connectors are in the coupling position. Hence, an even better fixation and a higher positive engagement can be achieved in the locking position of the legs of the locking element.

Another embodiment is characterized in that the base leg of the locking element, in particular its central section, is supported resting against the first plug connector at least in the coupling position. Hence, a clearer positioning of the locking element at the first plug connector can be achieved.

A further preferred embodiment is characterized in that the value of the second radial distance of the base leg amounts to a maximum prior to the respective insertion of the two second leg sections into the coupling groove. Hence, the maximum extension of the free bending length of each of the legs can be achieved at the largest radial widening of the two legs.

Furthermore, it can be advantageous if the base leg starting out from its center between the two legs has a roof-shaped angled longitudinal extension in the direction of the two legs. Hence, a better adaption to the outer geometry of the first plug connector can be achieved.

Another alternative embodiment is characterized in that the two first leg sections are aligned such that they run parallel to one another in the undeformed initial position of the locking element. This allows for better positional fixation of the locking element when the base leg is in the first position. In addition, however, a sufficiently good transverse guidance of the locking element during the axial slide-in or insertion movement and the associated transverse adjustment of the entire locking element can be made possible in this way.

A further possible and optionally alternative embodiment has the features that the base leg, each of the first leg sections, each of the leg connection sections and each of the second leg sections are arranged so as to extend in a common plane. In this way, a narrow embodiment of the coupling slots and the coupling groove can be made possible. In addition, good guidance of the locking element at least in the coupling slots can be achieved in this way.

A further embodiment provides that one support leg is arranged on each of the second leg sections at their end facing away from the base leg, and the support legs each have a longitudinal orientation which is aligned in a normal direction with respect to the common plane. This allows the two ends of the legs to be better guided on the outer surface of the first plug connector during their relative displacement.

Another embodiment is characterized in that the two support legs are each supported resting against the first plug connector body between the first position of the base leg and the second position of the base leg and vice versa. Depending on the alignment and embodiment of the respective contact surfaces, a forced return of the locking element from the second position of the base leg into its first, closer position can thus be achieved.

For the purpose of better understanding of the disclosure, it will be elucidated in more detail by means of the figures below.

### BRIEF DESCRIPTION OF THE DRAWINGS

These show in a respectively very simplified schematic representation:

FIG. 1 shows the plug assembly with its two plug connectors and the locking element in still separate position of the individual components from one another, in a graphic representation;

FIG. 2 shows the locking element according to FIG. 1 in an enlarged view;

FIG. 3 shows a cross-section through the plug assembly according to FIGS. 1 and 2 at the beginning of the insertion process with immediately adjacent arrangement or abutting support of the leg connection sections on the insertion piece of the second plug connector in a view against the insertion direction of the second plug connector;

FIG. 4 shows a further cross-section of the plug assembly, however, with abutting support of the second leg sections on the extending widening section of the second plug connector, in a view against the slide-in direction of the second plug connector;

FIG. 5 shows a further cross-section of the plug assembly, however with the locking elements being in the locking position in the coupling groove of the second plug connector;

FIG. 6 shows a detail of the support of an end section of a leg on the outer side or the outer surface of the first plug connector, in an axial view and in an enlarged representation.

### DETAILED DESCRIPTION

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

The term “in particular” shall henceforth be understood to mean that it may refer to a possible more specific formation or more detailed specification of an object or a process step, but need not necessarily depict a mandatory, preferred embodiment of same or a mandatory practice.

In their present use, the terms “comprising”, “has”, “having”, “includes”, “including”, “contains”, “containing” and any variations thereof are meant to cover a non-exclusive inclusion.

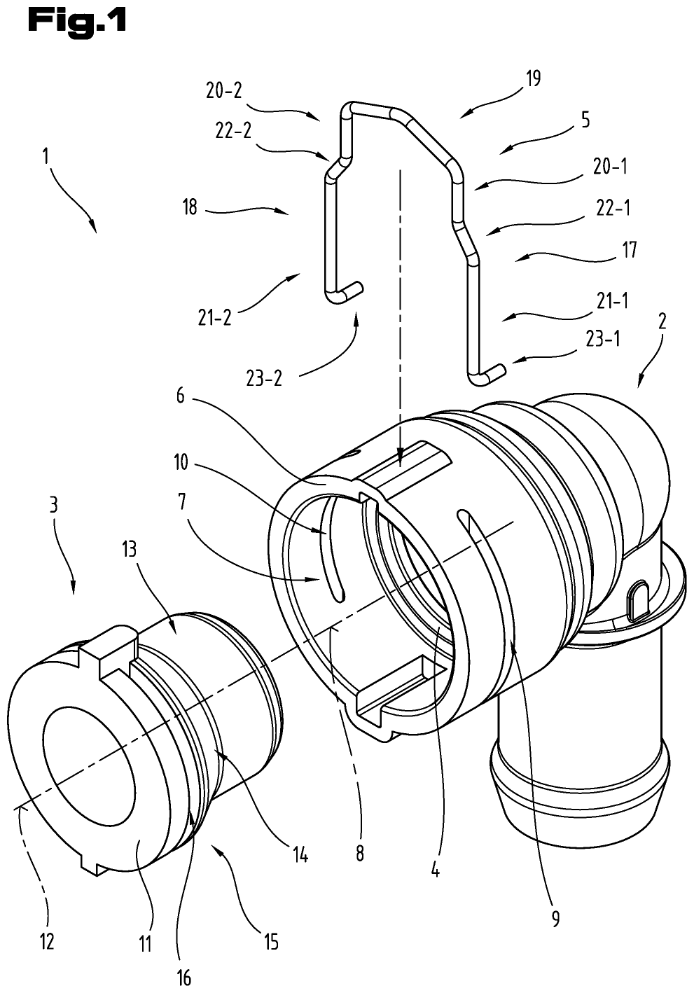

FIGS. 1 to 6 show and describe parts and components for the formation of the plug assembly 1, wherein the plug assembly 1 is embodied for connecting pipes for liquid and/or gaseous media. Below, both the individual parts and components as well as the method for mutual coupling are described.

The plug assembly 1 comprises a first female plug connector 2, a second male plug connector 3, a sealing element 4 and at least one locking element 5. For the sake of better overview, the representation and detailed description of connection pipes on both sides of the plug connectors 2, 3 was dispensed with.

The first plug connector 2 comprises a tube-shaped first plug connector body 6, which defines a female receiving space 7 with a first longitudinal axis 8. In the first plug connector body 6, a first coupling slot 9 and a second coupling slot 10 are arranged so as to diametrically oppose one another in known manner. The two coupling slots 9, 10 are embodied to or serve to receive and hold the locking element 5 in guiding arrangement.

The second plug connector 3, in turn, comprises a second plug connector body 11, which is also tube-shaped and defines a second longitudinal axis 12. The second plug connector body 11 comprises a hollow-cylindrical insertion piece 13, an adjoining frustoconically and/or conically extending widening section 14 and an adjoining coupling section 15. The components described above are arranged behind one another as seen against the insertion direction. Most times, the coupling section 15 is formed hollow-cylindrically and comprises at least one coupling groove 16. Depending on the arrangement and formation of the coupling section 15, the coupling groove 16 can be formed continuously across the circumference. However, it would also be possible to provide one coupling groove 16 in each case which diametrically oppose one another similarly to the two coupling slots 9, 10. In this case, the first coupling groove is referred to by reference number 16-1 and the second coupling groove is referred to by reference number 16-2. The at least one coupling groove 16 also serves in a known manner to be brought into or to stand in a releasable positive engagement with the locking element 5 when the plug connectors 2, 3 are in the assembled coupling position. If, as shown in the present exemplary embodiment, an additional anti-rotation device with cooperating first and second locking elements is also provided, the coupling groove 16 may be embodied so as to be interrupted.

The insertion piece 13 forms, at least in sections, a sealing surface for cooperating with the sealing element accommodated in the first plug connector 2 when the plug connectors 2, 3 are in the coupling position.

The locking element 5 is mostly or preferably formed of a metal material having spring properties. It is preferably made of an undeformed round wire. The base shape of the locking element 5 is selected to be strap-shaped, wherein the locking element 5 comprises a first leg 17, a second leg 18 and a base leg 19 connecting the two legs 17, 18 to one another. With respect to a central plane (M), the locking element 5 is formed mirror-invertedly, wherein, in the mounting position of the locking element 5 on the first plug connector 2, the central plane (M) is arranged extending along the first longitudinal axis 8. The two legs 17, 18 are arranged laterally spaced from the central plane (M). Starting from its center and/or the central plane (M) between the two legs 17, 18 the base leg 19 can have a roof-shaped angled longitudinal course in the direction of the two legs 17, 18.

Each of the legs 17,18 generally has the same components, which is why generally the same reference signs are used for it on both sides of the center plane (M), however with the addition “−1” or “−2”. Thus, each of the legs 17, 18 comprises a first leg section 20-1, 20-2, a second leg section 21-1, 21-2 and in each case a leg connection section 22-1, 22-2 connecting the respective leg sections 20-1, 21-1 and 20-2, 21-2 with one another.

The first leg sections 20-1, 20-2 are arranged on sides facing away from one another in each case or on ends on the base leg 19 so as to adjoin thereon. In the undeformed initial position of the locking element 5, at least the two second leg sections 21-1, 21-2 are aligned being predominantly parallel to one another or parallel to one another within certain limits. The two leg connection sections 22-1, 22-2 are aligned such that they run towards one another in the direction towards the base leg 19. The two second leg sections 21-1, 21-2 are arranged at a larger distance from one another in the normal direction with respect to the central plane (M) than the first leg sections 20-1, 20-2. As is apparent, the two first leg sections 20-1, 20-2 can also be aligned so as to run in parallel to one another in the undeformed initial position of the locking element 5.

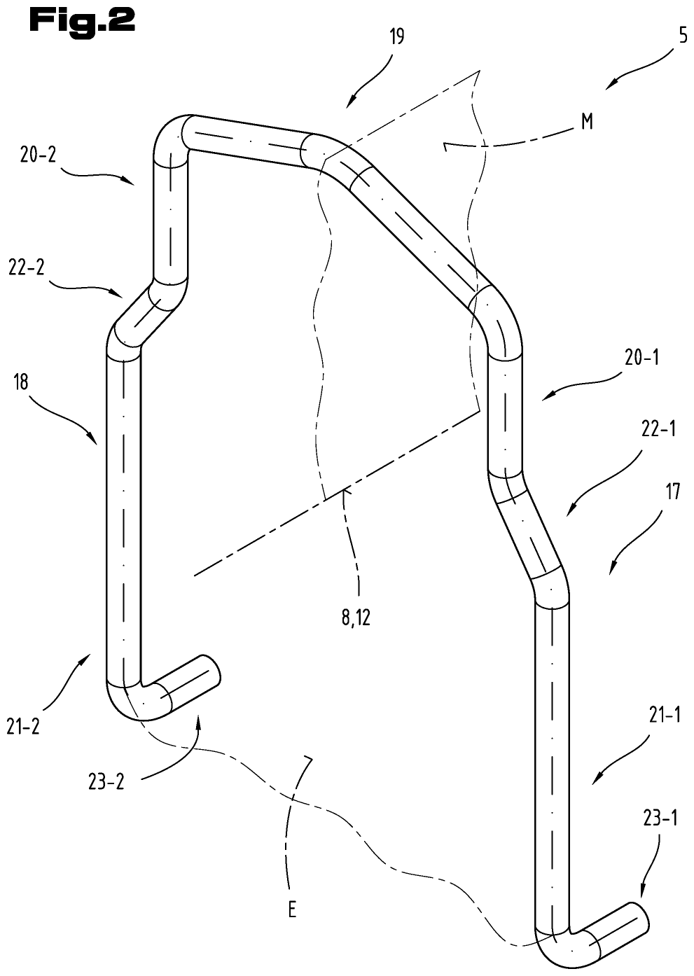

The base leg 19, each of the first leg sections 20-1, 20-2, each of the leg connection sections 22-1, 22-2 and also each of the second leg sections 21-1, 21-2 can also be arranged extending in a common plane (E). In addition, a separate support leg 20-1, 20-2 may be arranged on each of the second leg sections 23-1, 23-2 as a component of the locking element 5. The support legs 23-1, 23-2 are each arranged at the ends of the second leg sections 21-1, 21-2 facing away from the base leg 19, wherein the support legs 23-1, 23-2 each have a longitudinal orientation which is aligned in a normal direction with respect to the common plane (E). As can be seen from FIG. 2, the plane (E) forms a normal plane with respect to the longitudinal axes 8, 12, wherein the central plane (M) is arranged to extend in the longitudinal axes 8, 12 and thus forms a normal plane with respect to the plane (E).

The support leg 23-1, 23-2 may serve or be formed to be supported in abutment with the tubularly formed first plug connector body 6 in each case between the first position of the base leg 19 and the second position of the base leg 19 and vice versa. The two positions will be described in further detail below.

When the two plug connectors 2, 3 are in their coupling position, the locking element 5 engages with its first leg 17 in the first coupling slot 9 and in the coupling groove 16. However, simultaneously, the second leg 18 also engages in the second coupling slot 10 and also in the coupling groove 16.

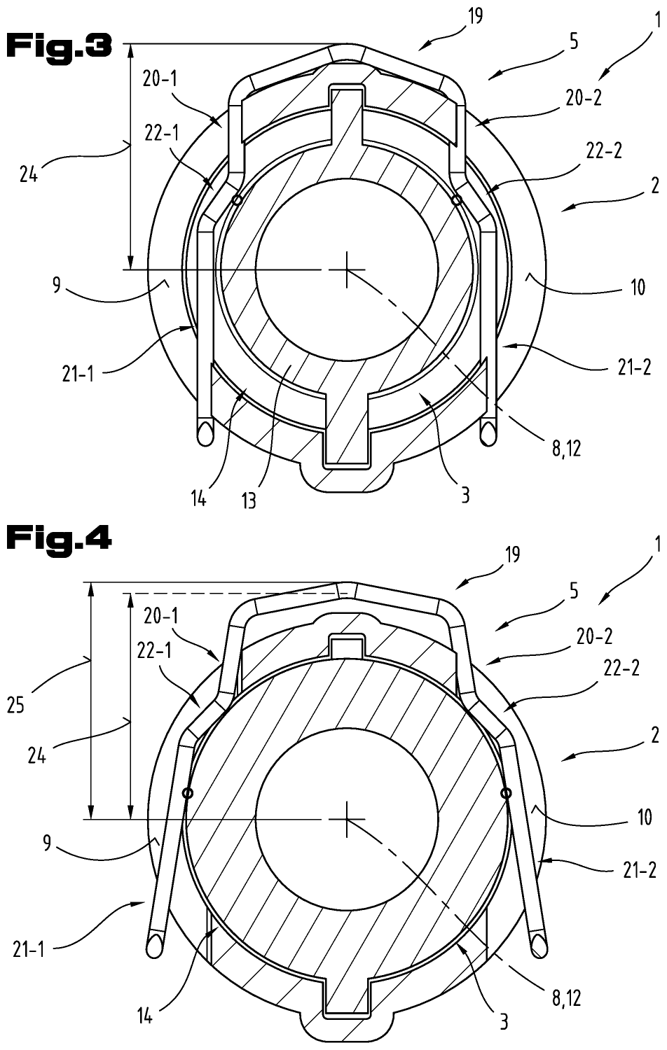

Before mutual joining and insertion of the two plug connectors 2, 3, the locking element 5 is inserted into the respectively provided coupling slots 9, 10 of the first plug connector body 6 with its two legs 17, 18 and held positioned therein. In this regard, the base leg 19 of the locking element 5 is arranged in its center between the two legs 17, 18 in a first position spaced at a first radial distance 24 from the first longitudinal axis 8, as can best be seen from FIGS. 1 and 3. In this undeformed and pre-mounted initial position of the locking element 5 on the first plug connector 2 with its coupling slots 9, 10, at least partial sections of the second leg sections 21-1, 21-2 and the leg connection sections 22-1, 22-2 project into the female receiving space 7 starting out from the two coupling slots 9, 10.

To now bring the two plug connectors 2, 3 into their coupling position with one another, a mutual alignment, preferably a flush alignment, of the two longitudinal axes 8, 12 of the two plug connectors 2, 3 is to be performed. Then, the two plug connectors 2, 3 are moved towards one another and the second plug connector 3 is step by step inserted into the female receiving space 7 of the first plug connector 2. The step by step insertion can be carried out according to the steps that will be described below.

In a first step (a), the insertion of the hollow-cylindrical insertion piece 13 into the female receiving space 7 is performed. In this regard, at least one of the two leg connection sections 22-1, 22-2 or the two leg connection sections 22-1, 22-2 in a partial section thereof can each be arranged to rest against the hollow cylindrical insertion piece 13—see FIG. 3 in this regard. Depending on the current arrangement of the locking element 5 on the first plug connector 2, it is possible that in the first step (a), the two leg connection sections 22-1, 22-2 are each arranged immediately adjacent to the hollow-cylindrical insertion piece 13 and just do not touch it. The contact points and/or first contact sections are indicated by a circle on both sides. This is due to the fact that the leg connection sections 22-1, 22-2 also project into the female receiving space 7 starting out from the two coupling slots 9, 10. The two leg connection sections 22-1, 22-2 are arranged closer to the base leg 19 than the two second leg sections 21-1, 21-2.

In the further following step (b), the insertion process is continued in the axial direction. In this regard, the two leg sections 21-1, 21-2 are each supported on the conically extending widening section 14 of the second plug connector body 11—see FIG. 4 in this regard. The contact points and/or second or further contact sections are indicated by a circle on both sides here as well. During this support of the two leg sections 21-1, 21-2 on the conically extending widening section 14, the two leg connection sections 22-1, 22-2 can be arranged spaced apart or distanced from the conically extending widening section 14.

Due to the locally changing supporting effect from the leg connection sections 22-1, 22-2 towards the second leg sections 21-1, 21-2 and the abutting support at the widening section 14, the base leg 19 of the locking element 5 is arranged in its center between the two legs 17, 18 in a second position spaced at a second radial distance 25 from the longitudinal axis 8, 12. The second radial distance 25 has a greater value than the first radial distance 24. The previously described first radial distance 24 is shown in dashed lines for the base leg 19.

The transverse adjustment of the locking element 5 is carried out by the axial slide-in and/or insertion movement and the interaction of the outwardly expanding widening section 14 with the different sections of the two legs 17, 18. No separate manual adjustment movement of the locking element 5 is required for this. Due to the insertion movement in the axial direction in conjunction with the leg connection sections 21-1, 21-2 extending at an angle with respect to the second leg sections 22-1, 22-2 and the displacement of the contact points and/or contact sections, the axial force is deflected to a certain extent into an adjusting force aligned in the transverse direction thereto. This adjusting force effects the relative displacement of the locking element 5 in the transverse direction and/or in the radial direction.

Hence, a larger distancing of the base leg 19 from the longitudinal axis 8, 12 is achieved. By this lifting or raising of the entire locking element 5 in the transverse direction, there is also an extension of the lever or the lever arm of each of the two legs 17, 18 from the respective support point or support section and/or contact section on the second plug connector body 11 towards the transition area of the respective leg 17, 18 onto the base leg 19. By displacing the respective first contact sections on the leg connection sections 22-1, 22-2 towards the second or further contact sections on the second leg sections 21-1, 21-2 further spaced from the ends of the base leg and/or to the transition sections thereto, the two levers or lever arms are lengthened and thus the required insertion force (axial force) is reduced.

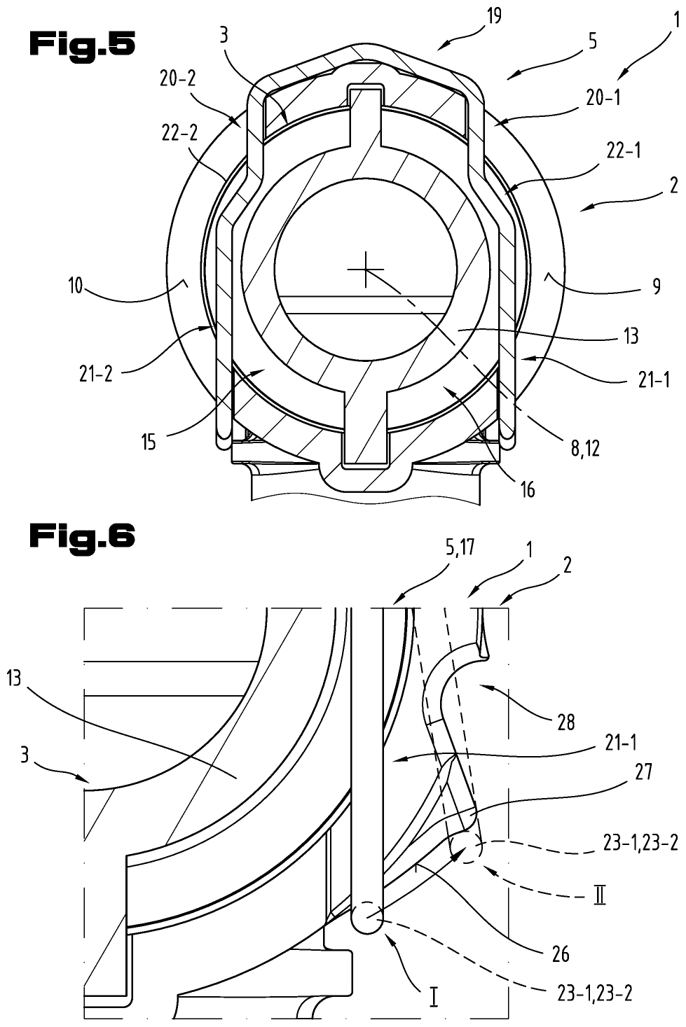

In the subsequent further step (c) of the insertion process in the axial direction, the two plug connectors 2, 3 are brought into their intended mutual coupling position. In this regard, the locking element 5 expanded on both sides with its two legs 17, 18 came into an overlapping position with the coupling groove 16. Once this position has been reaches, the second leg section 21-1 of the first leg 17 engages in both the first coupling slot 9 and the coupling groove 16—see FIG. 5 in this regard. However, the same applies to the second leg 18. Its second leg section 21-2 engages in both the second coupling slot 10 and the coupling groove 16. Thus, the insertion and coupling process is carried out and completed. The previously expanded position of the two legs 17, 18 is reversed by the snapping into the coupling groove 16. A certain residual pretensioning of the two legs 17, 18 in the direction towards the longitudinal axis 8, 12 can be maintained.

When the locking position between the locking element 5 and the second plug connector 3 inserted into the first plug connector 2 has been reached, the two plug connectors 2, 3 are also in their coupling position. In this regard, the locking element 5 with its base leg 19 is adjusted back into the first position in which the base leg 19 is arranged closer to the longitudinal axis 8, 12 than in its second position.

In step (a) described above of the axial insertion process of the second plug connector 3 into the female receiving space 7 of the first plug connector 2, the two second leg sections 21-1, 21-2 can each be arranged spaced apart from the hollow-cylindrical insertion piece 13 in the radial direction. Furthermore, it is possible that after the beginning of step (b), the two leg connection sections are lifted off the conically extending widening section. This can be carried out because a change of the support point or support section of the leg connection sections 22-1, 22-2 towards the second leg sections 21-1, 21-2 is entailed.

However, it is also possible that during step (b) of the axial insertion process, the radial distance of the center of the base leg 19 is continuously increased starting from the value of the first radial distance 24 to the second value of the second radial distance 25. The further the second plug connector 3 is inserted into the first plug connector 2, the further the two legs 17, 18, in particular their second leg sections 21-1, 21-2 slide along the contact surface of the extending widening section 14. By the widening process of the two legs 17, 18, the base leg 19 is further distanced from the longitudinal axis 8, 12.

When the two plug connectors 2, 3 are in their coupling position and the locking element 5 with its two legs 17, 18 is in locking engagement with the coupling groove 16, the two leg connection sections 22-1, 22-2 of the locking element 5 each can also be arranged or accommodated in the coupling groove 16 with the majority of their length. Furthermore, it can be advantageous if the base leg 19 of the locking element 5, in particular its central section, is supported resting against the outer side of the first plug connector 2 at least in the coupling position.

Once the two legs 17, 18 in particular their second leg sections 21-1, 21-2, have passed the widening section 14 and are still in the subsequent coupling section 15 before engaging or snapping into the coupling groove 16, the value of the second radial distance 25 of the base leg 19 from the longitudinal axis 8, 12 is a maximum and/or a maximum value.

As previously described and as can best be seen from FIG. 6, the two support legs 23 can be supported with their approximately parallel orientation with respect to the longitudinal axis 8, 12 always abutting on the first plug connector body 6 of the first plug connector 2. Due to the respective alignment of guide surfaces 26 inclined towards each other on the side facing away from the base leg 19, the return movement of the locking element 5 from the second position of the base leg 19 to the first position closer to the first plug connector 2 can thus be facilitated or even supported. Furthermore, however, if at least one stop element 27 is provided, the relative adjustment movement and thus the adjustment path of the locking element 5 from the position of the base leg 19 closer to the longitudinal axis 8, 12 to the second position can thus also be limited. The first position of the locking element 5 with its base leg 19 described above is designated with the Roman numeral “I” for the support leg 23-1 and/or the support leg 23-2 and with the Roman numeral “II” for the second position.

In order to move the two legs 17, 18 with their partial sections out of locking engagement with the coupling groove 16, the locking element 5 is to be displaced manually with its base leg 19 to by the longitudinal axis 8, 12. This adjustment movement allows the support legs 23-1, 23-2 to be displaced into a retaining recess 28. In this regard, the two legs 17, 18 are spaced apart and widened to such an extent that the second plug connector 3 can be pulled out of the first plug connector 2 against the insertion direction without colliding with the two legs 17, 18.

Lastly, it is noted that the individual method steps and their chronological sequence do not obligatorily have to be carried out in the stated order, but a chronological order differing from this is also possible.

The exemplary embodiments show possible embodiment variants, and it should be noted in this respect that the disclosure is not restricted to these particular illustrated embodiment variants of it, but that rather also various combinations of the individual embodiment variants are possible and that this possibility of variation owing to the technical teaching provided by the present disclosure lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE NUMBERS

1 Plug assembly
2 First plug connector
3 Second plug connector
4 Sealing element
5 Locking element
6 First plug connector body
7 Receiving space
8 First longitudinal axis
9 First coupling slot
10 Second coupling slot
11 Second plug connector body
12 Second longitudinal axis
13 Insertion piece
14 Widening section
15 Coupling section
16 Coupling groove
17 First leg
18 Second leg
19 Base leg
20 First leg section
21 Second leg section
22 Leg connection section
23 Support leg
24 First radial distance
25 Second radial distance
26 Guide surface
27 Stop element
28 Retaining recess
(E) Plane
(M) Central plane

1. A method for coupling plug connectors to form a plug assembly, which is formed for connecting pipes for liquid and/or gaseous media, in which method the following steps are carried out:
providing a first female plug connector, said first plug connector comprising a tube-shaped first plug connector body, which defines a female receiving space with a first longitudinal axis, wherein at least a first coupling slot and a second coupling slot are arranged in the first plug connector body so as to diametrically oppose one another,
providing a second male plug connector, said second plug connector having a tube-shaped second plug connector body with
a hollow-cylindrical insertion piece,
an adjoining conically extending widening section, and with
an adjoining coupling section with a coupling groove, wherein the second plug connector body defines a second longitudinal axis,
providing at least one sealing element and arranging it in the first female plug connector,
providing a locking element, said locking element being strap-shaped and being in a releasable positive engagement with the two plug connectors when the plug connectors are in the coupling position, the locking element comprising:
a first leg,
a second leg and
a base leg, said base leg connecting the two legs to one another, each of the two legs in each case comprising:
a first leg section,
a second leg section and
a leg connection section, which leg connection section connects the first leg section and the second leg section to one another in each case, and the first leg sections are arranged adjoining the base leg on sides facing away from one another in each case, wherein at least the two second leg sections are aligned such that they run parallel to one another in the undeformed initial position, and furthermore the two leg connection sections are aligned such that they run towards one another in the direction of the base leg,
arranging the locking element in the two coupling slots of the first plug connector body, and, in this process, arranging the base leg of the locking element in its center between the two legs in a first position spaced at a first radial distance from the first longitudinal axis,
orienting the longitudinal axes of the two plug connectors with respect to each other,
moving the two plug connectors towards each other and step by step inserting the second plug connector into the female receiving space of the first plug connector,
(a) inserting the hollow-cylindrical insertion piece, in which the two leg connection sections are each arranged in a partial section thereof directly adjacent to the hollow-cylindrical insertion piece or resting on the hollow-cylindrical insertion piece against first contact sections,
(b) continuing the insertion process in the axial direction, in which the two second leg sections are each supported on the conically extending widening section adjoining further contact sections, and, in this process, the base leg of the locking element is arranged in its center between the two legs in a second position at a second radial distance from the longitudinal axis, and the second radial distance has a greater value than the first radial distance,
(c) continuing the insertion process in the axial direction, in which, when the first and second plug connectors are in the mutual coupling position, the locking element engages with its second leg section of the first leg in the first coupling slot and in the coupling groove, and the second leg engages with its second leg section in the second coupling slot and in the coupling groove.

2. The method according to claim 1, characterized in that, when the coupling position is reached, the locking element with its base leg is moved back to the first position.

3. The method according to claim 1, characterized in that during step (a) of the axial insertion process of the second plug connector into the female receiving space of the first plug connector, the two second leg sections are each arranged at a distance from the hollow cylindrical insertion piece in the radial direction.

4. The method according to one of the preceding claims, characterized in that after the beginning of step (b), the two leg connection sections are lifted off the conically extending widening section.

5. The method according to claim 1, characterized in that during step (b) of the axial insertion process, the radial distance of the center of the base leg is continuously increased starting from the value of the first radial distance to the second value of the second radial distance.

6. The method according to claim 1, characterized in that the two leg connection sections of the locking element are arranged or accommodated in the coupling groove over the majority of their length when the plug connectors are in the coupling position.

7. The method according to claim 1, characterized in that the base leg of the locking element, in particular its central section, is supported resting against the first plug connector at least in the coupling position.

8. The method according to claim 1, characterized in that the value of the second radial distance of the base leg from the longitudinal axis amounts to a maximum after leaving the widening section of the two legs and prior to the respective insertion of the two second leg sections into the coupling groove.

9. A plug assembly for connecting pipes for liquid and/or gaseous media, comprising:
a first female plug connector, said first plug connector comprising a tube-shaped first plug connector body, which defines a female receiving space with a first longitudinal axis, wherein at least a first coupling slot and a second coupling slot are arranged in the first plug connector body so as to diametrically oppose one another,
a second male plug connector, said second plug connector having a tube-shaped second plug connector body with
a hollow-cylindrical insertion piece,
an adjoining conically extending widening section, and with
an adjoining coupling section with at least one coupling groove, where-in the second plug connector body defines a second longitudinal axis,
wherein the two plug connectors can be brought into a releasable coupling position in the axial direction,
at least one sealing element, said sealing element being arranged in the first female plug connector,
a locking element, said locking element being strap-shaped and being in a releasable positive engagement with the two plug connectors in the coupling position, the locking element comprising:
a first leg,
a second leg and
a base leg, said base leg connecting the two legs to one another, each of the two legs in each case comprising:
a first leg section,
a second leg section and
a leg connection section, which leg connection section connects the first leg section and the second leg section to one another in each case, and the first leg sections are arranged adjoining the base leg on sides facing away from one another in each case, wherein at least the two second leg sections are aligned such that they run parallel to one another in the undeformed initial position, and furthermore the two leg connection sections are aligned such that they run towards one another in the direction of the base leg,
wherein, when the first and second plug connectors are in the coupling position, the locking element engages with its first leg in the first coupling slot and in the coupling groove and the second leg engages in the second coupling slot and in the coupling groove, and
wherein the base leg of the locking element, at least in the coupling position, is arranged in its center between the two legs in a first position spaced apart from the longitudinal axis at a first radial distance, in particular for carrying out the method according to one of the preceding claims,
characterized in
that, at the beginning of axial insertion of the second plug connector into the female receiving space of the first plug connector, in each case the two leg connection sections are arranged in a partial section thereof directly adjacent to the hollow-cylindrical insertion piece or resting on the hollow-cylindrical insertion piece against first contact sections,
that, during further insertion in the axial direction, the two second leg sections are in each case supported resting against further contact sections on the conically extending widening section,
that, at least in the position of the second leg sections resting against the conically extending widening section, the base leg of the locking element is arranged in its center between the two legs in a second position at a second radial distance from the longitudinal axis, and
that the second radial distance has a greater value than the first radial distance.

10. The plug assembly according to claim 9, characterized in that the base leg is set back into its first position when the locking element is in the coupling position.

11. The plug assembly according to claim 9, characterized in that during the beginning of the axial insertion process of the second plug connector into the female receiving space of the first plug connector, the two second leg sections are each arranged at a distance from the hollow cylindrical insertion piece in the radial direction.

12. The plug assembly according to claim 9, characterized in that when the two second leg sections are supported on the conically extending widening section, the two leg connection sections are arranged at a distance from the conically extending widening section.

13. The plug assembly according to claim 9, characterized in that the two leg connection sections of the locking element are arranged or accommodated in the coupling groove over the majority of their length when the plug connectors are in the coupling position.

14. The plug assembly according to claim 9, characterized in that the base leg of the locking element, in particular its central section, is supported resting against the first plug connector at least in the coupling position.

15. A plug assembly for connecting pipes for liquid and/or gaseous media, comprising:
a first female plug connector, said first plug connector comprising a tube-shaped first plug connector body, which defines a female receiving space with a first longitudinal axis, wherein at least a first coupling slot and a second coupling slot are arranged in the first plug connector body so as to diametrically oppose one another;
a second male plug connector, said second plug connector having a tube-shaped second plug connector body with
a hollow-cylindrical insertion piece,
an adjoining conically extending widening section, and
an adjoining coupling section with at least one coupling groove, where-in the second plug connector body defines a second longitudinal axis,
at least one sealing element, said sealing element being arranged in the first female plug connector; and
a locking element operable to be in a releasable positive engagement with the two plug connectors in the coupling position, the locking element comprising:
a first leg,
a second leg and
a base leg, said base leg connecting the two legs to one another.

16. The plug assembly according to claim 15, wherein the base leg starting out from its center between the two legs has a roof-shaped angled longitudinal extension in the direction of the two legs.

17. The plug assembly according to claim 15, wherein the two first leg sections are aligned such that they run parallel to one another in an undeformed initial position of the locking element.

18. The plug assembly according to claim 15, wherein the base leg, the first leg sections, each of and the second leg sections are arranged extending in a common plane (E).

19. The plug assembly according to claim 18, characterized in that one support leg is arranged on the second leg sections at its end facing away from the base leg, and the support legs has a longitudinal orientation which is aligned in a normal direction with respect to the common plane (E).

20. The plug assembly according to claim 19, characterized in that the support legs is supported resting against the first plug connector body between a first position of the base leg and a second position of the base leg.
